(19) United States
(12) Patent Application Publication
(10) Pub. No.: US 2016/0175625 A1
(43) Pub. Date: Jun. 23, 2016

(54) Safety Appliance

(71) Applicant: Polyunion Textile, Shenzhen City (CN)

(72) Inventor: Chung Che Chui, Shenzhen (CN)

(73) Assignee: Polyunion Textile, Shenzhen City (CN)

(21) Appl. No.: 14/591,112

(22) Filed: Jan. 7, 2015

(30) Foreign Application Priority Data
Dec. 17, 2014 (CN) 201420794513.X

(51) Int. Cl. A62B 35/00

(52) U.S. Cl. CPC A62B 35/00

(57) ABSTRACT

The present utility model discloses a safety appliance, comprising a seamless annular webbing and a filler wrapped within the seamless annular webbing, the seamless annular webbing being annular and seamless and having webbing layers wrapped layer upon layer in the cross-section thereof, the filler being arranged in the middle of the seamless annular webbing. The arrangement of the filler can provide effective protection, the seamless annular webbing wrapping around the filler can effectively prevent the safety appliance from breaking. The safety appliance provided by the present utility model is simple in structure, safe and reliable in use, and not easy to break.

### TECHNICAL FIELD

The present utility model relates to the technical field of climbing, in particular to a safety appliance.

### BACKGROUND OF THE PRESENT INVENTION

In the prior art, most of safety appliances used in aspects such as climbing or competitive sports are of a multilayer-sewn structure. That is, a filler for providing protection is filled in a hollow webbing, and then the two ends of the hollow webbing is sewn together. For a safety appliance made in such a manner, the stitches at the joints are very prone to get worn and then break during long-term use in high-strength environments, causing great safety hazards.

### SUMMARY OF THE PRESENT INVENTION

An objective of the utility model is to provide a safety appliance that is simple in structure, safe and reliable in use, and not easy to break.

To realize this purpose, the present utility model employs the following technical solutions.

A safety appliance is provided, including a seamless annular webbing and a filler wrapped within the seamless annular webbing, the seamless annular webbing being annular and seamless and having webbing layers wrapped layer upon layer in the cross-section thereof, the filler being arranged in the middle of the seamless annular webbing.

The seamless annular webbing is formed by wrapping a hollow webbing of a tubular monolayer structure layer upon layer, and a distal end of the hollow webbing of a tubular monolayer structure is integrally seamless-woven with an outer side wall of the shaped seamless annular webbing.

The safety appliance is formed by integrally wrapping the filler by a seamless annular webbing loom.

The filler is integrally molded from high-strength cushioning material.

The filler is a band having a wide middle part and gradually narrowed two ends.

The present utility model has the following beneficial effects. The safety appliance provided by the present utility model includes a seamless annular webbing and a filler wrapped within the seamless annular webbing, the seamless annular webbing being annular and seamless and having webbing layers wrapped layer upon layer in the cross-section thereof, the filler being arranged in the middle of the seamless annular webbing. The arrangement of the filler can provide effective protection, the seamless annular webbing wrapping around the filler can effectively prevent the safety appliance from breaking. The safety appliance provided by the present utility model is simple in structure, safe and reliable in use, and not easy to break.

### BRIEF DESCRIPTION OF THE DRAWINGS

FIG. 1 is an axial diagram of a safety appliance according to the present utility model;

FIG. 2 is a structural diagram of a cross-section AA of FIG. 1; and

FIG. 3 is a diagram of processing the safety appliance according to the present utility model,

in the drawings:

1—Filler; 2—Seamless annular webbing; 21—Webbing layer; 3—Silk thread

### DETAILED DESCRIPTION OF THE PRESENT INVENTION

The technical solutions of the present utility model will be further described with reference to the accompanying drawings by specific implementations.

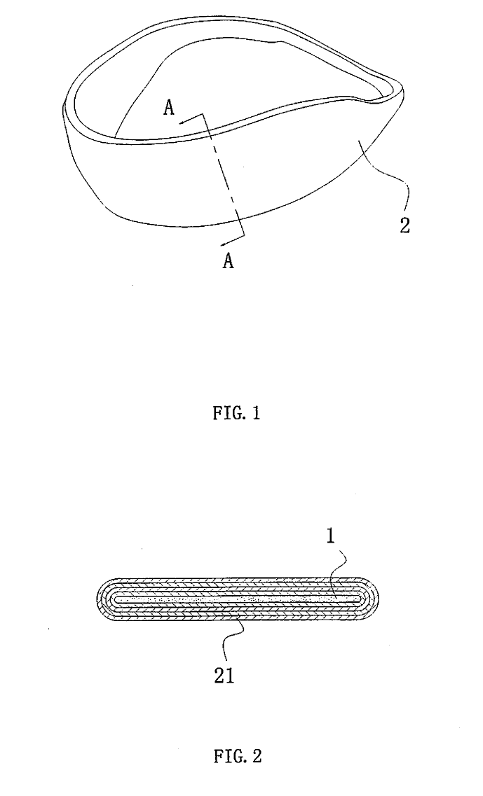

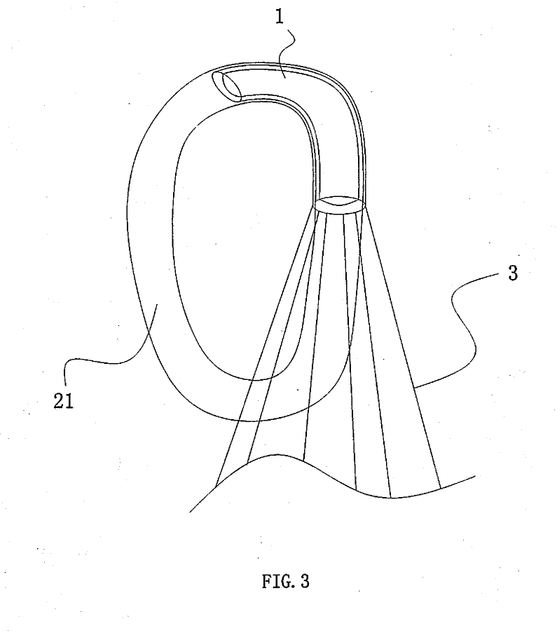

As shown in FIG. 1 and FIG. 2, a safety appliance is provided, including a seamless annular webbing 2 and a filler 1 wrapped within the seamless annular webbing 2, the seamless annular webbing 2 being annular and seamless and having webbing layers 21 wrapped layer upon layer in the cross-section thereof, the filler 1 being arranged in the middle of the seamless annular webbing 2. As a preferred implementation of the present utility model, as shown in FIG. 3, the seamless annular webbing 2 is formed by wrapping a hollow webbing of a tubular monolayer structure layer upon layer, and a distal end of the hollow webbing of a tubular monolayer structure is integrally seamless-woven with an outer side wall of the shaped seamless annular webbing 2. Preferably, during wrapping the hollow webbing layer upon layer, the filler is first placed into the first section of the hollow webbing, the outer hollow webbing layer is then wrapped layer upon layer during the weaving via a silk thread 3, and finally the distal end is integrally seamless-woven with an outer side wall of the shaped seamless annular webbing 2. In this way, joints are effectively avoided to prevent the safety appliance from breaking. As an implementation, the safety appliance is formed by integrally wrapping the filler 1 by a seamless annular webbing loom.

As a further implementation of the present utility model, the filler 1 is integrally molded from high-strength cushioning material, for example, high-strength plastic parts or high-cushioning rubbers. Better protection may be further provided.

As a preferred implementation, the filler 1 is a band having a wide middle part and gradually narrowed two ends. Hence, the seamless annular webbing 2 tightly wraps the filler to form a safety appliance having a shape consistent to that of the filler. The filler may be designed into other shapes, if desired.

Although the technical principle of the present utility model has been described above by specific embodiments, these descriptions are merely provided to explain the principle of the present utility model and shall be not constructed in any way as limiting the protection scope of the present utility model. Based on the explanations herein, a person of ordinary skill in the art may come up with other specific implementations of the present utility model without any creative efforts, and such implementations shall fall into the protection scope of the present utility model.

1. A safety appliance, comprising a seamless annular webbing (2) and a filler (1) wrapped within the seamless annular webbing (2), the seamless annular webbing (2) being annular and seamless and having webbing layers (21) wrapped layer upon layer in the cross-section thereof, the filler (1) being arranged in the middle of the seamless annular webbing (2).

2. The safety appliance according to claim 1, characterized in that the seamless annular webbing (2) is formed by wrapping a hollow webbing of a tubular monolayer structure layer upon layer, and a distal end of the hollow webbing of a tubular monolayer structure is integrally seamless-woven with an outer side wall of the shaped seamless annular webbing (2).

3. The safety appliance according to claim 1, characterized in that the safety appliance is formed by integrally wrapping the filler (1) by a seamless annular webbing loom.

4. The safety appliance according to claim 1, characterized in that the filler (1) is integrally molded from high-strength cushioning material.

5. The safety appliance according to claim 1, characterized in that the filler (1) is a band having a wide middle part and gradually narrowed two ends.
